(19) United States
(12) Patent Application Publication
(10) Pub. No.: US 2024/0288309 A1
(43) Pub. Date: Aug. 29, 2024

(54) TUNABLE HYPERSPECTRAL-POLARIMETRIC IMAGING SYSTEM

(71) Applicant: Purdue Research Foundation, West Lafayette, IN (US)

(72) Inventors: Xueji Wang, West Lafayette, IN (US); Zubin Jacob, West Lafayette, IN (US)

(21) Appl. No.: 18/573,375

(22) PCT Filed: Jun. 23, 2021
(86) PCT No.: PCT/US2021/038703

§ 371 Date: Dec. 21, 2023

(51) Int. Cl. G01J 4/04; G01J 3/02; G01J 3/28; G01J 3/447

(52) U.S. Cl. CPC G01J 4/04; G01J 3/0229; G01J 3/0237; G01J 3/2823; G01J 3/447; G01J 2003/2826

(57) ABSTRACT

A tunable hyperspectral-polarimetric filter system includes a first polarizer, a crystal filter and a second polarizer. The first polarizer is configured to transmit light in a first direction of linear polarization. The polarization selection may be substantially the same for all wavelengths at a spectral range of interest. The crystal filter, may be parallelly and coaxially disposed after the first polarizer. The crystal filter is configured to rotates the first direction of linear polarization for light transmitted by the first polarizer, wherein rotation angles differ for different wavelengths at the spectral range of interest. The second polarizer may be parallelly and coaxially disposed after the crystal filter. The second polarizer may substantially transmit a second direction of linear polarization of the light transmitted by the crystal filter. The first polarizer and/or the second polarizer are rotatable to tune for different transmission spectra for spectral and polarimetric imaging resolution.

This invention was made with government support under W911NF-21-2-0047 awarded by the U.S. Army Research Office. The government has certain rights in the invention.

### TECHNICAL FIELD

This disclosure relates to imaging systems using sensors and more particularly a tunable hyperspectral-polarimetric imaging system.

### BACKGROUND

Hyperspectral-polarimetric imaging has the ability to generate rich information associated with a scene that is hidden in traditional monochromatic or Red Green Blue (RGB) imaging. In medical applications, hyperspectral-polarimetric imaging offers opportunities for noninvasive disease diagnosis and surgical guidance. In agricultural production, hyperspectral-polarimetric imaging may be used in various applications such as food quality and safety inspection and plant health monitoring. Recent rapid developments in computer vision and autonomous driving also generate needs for high quality, information-dense image data, where hyperspectral polarimetric imaging may be one of the more promising solutions.

### BRIEF DESCRIPTION OF THE DRAWINGS

FIG. 1 is a schematic diagram of an example tunable hyperspectral-polarimetric imaging system.

FIG. 2 is a schematic example of a crystal filter.

FIG. 3 is an operational flow diagram illustrating example operation of a tunable hyperspectral-polarimetric filter system.

FIG. 4 is a continuation of the operational flow diagram of FIG. 3.

FIGS. 5a and 5b are examples of transmission spectrum output at different polarization angles from a second polarizer included in the tunable hyperspectral-polarimetric filter system.

FIGS. 6a and 6b are examples of calculated optical rotary power plotted for examples of crystal filters.

FIG. 7 is an example tunable transmission spectrum output by the tunable hyperspectral-polarimetric filter system at different polarization angles of a first polarizer included in the tunable hyperspectral-polarimetric filter system.

FIG. 8 is examples of some reconstructed false-color spectral images output by the tunable hyperspectral-polarimetric imaging system.

FIG. 9 are examples of an original monochromatic image (FIG. 9a), and output from the tunable hyperspectral-polarimetric imaging system of a degree of linear polarization image (FIG. 9b) and an angle of linear polarization image (FIG. 9c).

### DETAILED DESCRIPTION

Disclosed is a tunable hyperspectral-polarimetric imaging system. The system may be deployed in any device or system capable of receiving electromagnetic radiation, such as light, and sensing transmission spectra, or spectral frames output from the tunable hyperspectral-polarimetric imaging system. An example of the tunable hyperspectral-polarimetric imaging system includes a first polarizer, a crystal filter, a second polarizer and a sensor. The first polarizer is configured to generate from electromagnetic radiation a polarized electromagnetic radiation of one direction comprising a plurality of wavelength. The crystal filter is in optical axial alignment with the first polarizer. The crystal filter is configured to receive and dispersively rotate the polarized electromagnetic radiation of one direction with a different rotation angle for each of the wavelengths to generate a different direction of polarization for each respective wavelength. The second polarizer is in optical axial alignment with the crystal filter. The second polarizer is configured as a tunable spectral filter to generate a transmission spectra at each of a plurality of different polarization directions according to an axial orientation of the second polarizer with respect to an optical axis of the second polarizer. The sensor is configured to generate a spectral frame for the transmission spectra at each of the plurality of different polarization directions. The spectral frame representative of a spectral image at a respective polarization direction.

The first generation of hyperspectral imagers used a filter-wheel-based approach, where different bandpass filters are mounted in the system and a mechanical rotatory wheel is always required. Such systems are bulky and slow. The spectral resolution is also limited by the number of filters that a system can accommodate. The next-generation design, often called ‘pushbroom hyperspectral imaging’, replaces the filter wheel with optical dispersion elements like prisms or diffraction gratings to generate 2D spectral images of a 1 D line, then the 2D scene is swept across by line-scanning with a precise moving part. This design is limited by the scanning speed and system volume. Tunable spectral filters including the liquid crystal tunable filters, the acoustic optical tunable filters, and interferometer-based tunable filters may be used to address speed and system volume deficiencies by providing a single optical element with tunable transmission spectra. Such tunable-filter-based imaging systems may be prohibitively complex and resource intensive due to the adoption of rare materials and precise environmental control requirements.

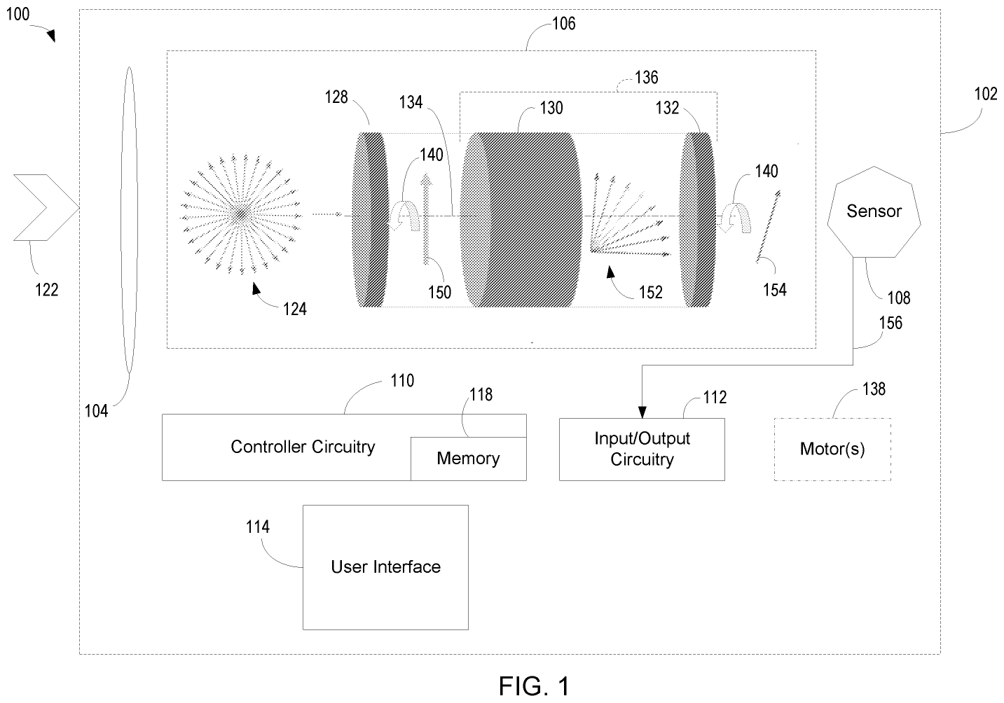

FIG. 1 is a schematic diagram of an example tunable hyperspectral-polarimetric imaging system 100. In the illustrated example the tunable hyperspectral-polarimetric imaging system 100 is disposed in a housing 102 that includes a lens 104, a hyperspectral-polarimetric imaging filter 106, a sensor 108, controller circuitry 110, input/output circuitry 112 and a user interface 114. In other example configurations, parts of the system 100 may be omitted. For example, the lens 104, sensor 108 and user interface 114 may be omitted and the hyperspectral-polarimetric imaging filter 106 and controller circuitry 110 may be interfaced via the I/O circuitry 112 to another system or device, such as a camera, having the omitted parts/functionality. In still other examples, the controller circuitry 110 may be omitted where the functionality described herein is provided by another system or device via the input/output circuitry 112 to control and operate the hyperspectral-polarimetric imaging filter 106.

The housing 102 may be any form of rigid structure capable of containing the identified parts of the system. The lens 104 may be any transparent rigid structure, such as glass mounted to the housing 102 and capable of provide transmission of electromagnetic radiation, such as light, from a scene external to the housing 102. For purposes of discussion, the term “light” will be used herein to describe electromagnetic radiation, however, it should be understood that any electromagnetic waves in the electromagnetic spectrum and their respective wavelengths may be used for hyperspectral-polarimetric imaging with the system 100.

Input light 122 may be received and passed through (transmitted through) the lens 104 as un-polarized incident light 124 into the hyperspectral-polarimetric imaging filter 106. In other examples, the lens 104 may perform some amount of filtering or other modification of the light, such as transmitting the input light in the visible range of the electromagnetic spectrum and blocking the infrared part.

The hyperspectral-polarimetric imaging filter 106 may include a first polarizer (or first stage polarizer) 128, a crystal filter 130 and a second polarizer (or second stage polarizer) 132 which may be in optical communication by, for example, being coaxially positioned along an optical axis 134. Accordingly, each of the first and second polarizers 128 and 132 and the crystal filter 130 may include a respective optical axis 134, by which the first and second polarizers 128 and 132 and the crystal filter 130 may be optically aligned for optical communication of light. In other examples, other types of alignment to provide optical communication are possible, such as outside diameter alignment (as illustrated by dotted lines in the example of FIG. 1), using mirrors or other reflective or partially reflective surfaces, and the like. In this regard, the first and second polarizers 128 and 132 and the crystal filter 130 are illustrated as cylindrical, however, other shapes, such as rectangular, spherical and other symmetrical or non-symmetrical shapes are possible. In still other examples, the respective optical axis 134 of the first and second polarizers 128 and 132 and the crystal filter 130 may be aligned in parallel to provide optical communication therebetween.

In other examples, there may be multiple crystal filters 130 and multiple second polarizers 132 that are sequentially and optically aligned. Thus, the hyperspectral-polarimetric imaging filter 106 may include a first polarizer (or first stage polarizer) 128, and multiple optical groups 136. Each of the optical groups 136 may include a crystal filter 130 and a second polarizer 132. For example, a first optical group 136 may be formed by the combination of a first one of a plurality of crystal filters 130 and a first one of a plurality of second polarizers (or second stage polarizers) 132, and a second optical group 136 may be formed by the combination of a second one of the plurality of crystal filters 130 and a second one of the plurality of second polarizers (or second stage polarizers) 132. The multiple optical groups 136 containing a crystal filter 130 and a second polarizer 132 may be in optical communication with each other by, for example, being coaxially positioned along the optical axis 134.

Within different ones of the multiple optical groups 136, the crystal filter 130 may have crystals oriented or positioned as either right-handed crystals having a clockwise rotational direction of polarization for the electromagnetic radiation wave or left-handed crystals having a counter-clockwise rotational direction of polarization for the electromagnetic radiation wave. Accordingly, the degree of rotation of the polarization may be controlled according to the number of optical groups 136 by selectively using crystal filters 130 with right-handed and left-handed oriented crystals in the different optical groups 136.

The first and second polarizers 128 and 132 may each include an optical filter that allows light waves of specific polarization direction to pass through while blocking light waves of other polarization directions. The first polarizer 128 and the second polarizer 132 may be linear polarizers, such that electromagnetic radiation waves transmitted by the first and second polarizers 128 and 132 may be linear electromagnetic radiation waves. Example polarizers include linear polarizers which may be absorptive linear polarizers that absorb light waves of other polarization directions, and beam-splitting linear polarizers that split other polarization directions into perpendicular propagation light. For example, the first polarizer 128 and the second polarizer 132 may be broadband wired-grid polarizers, primarily composed of Zinc Selenide (ZnSe), Thallium Bromoiodide (KRS-5) or Germanium (Ge). In other examples, the first and second polarizers 128 and 132 may be other forms of polarizers, such as a spatially varying polarizer, a coded polarization aperture, or any other form of polarizer that can provide polarization selectivity.

Orientation of the first and second polarizers 128 and 132 may be independently controlled to change the direction of polarization of light transmitted through the respective first and second polarizers 128 and 132. This may be described as independently tuning the first and second polarizers 128 and 132 to transmit light in a desired polarization direction by adjusting the degree of rotation or rotation angle. The degree of rotation, or rotation angle, may be a measurement in degrees from a predetermined zero degrees point, such as a vertical direction of polarization. Accordingly, in the example of the zero degrees point being a vertical direction of polarization, a horizontal direction of polarization may be ninety degrees.

In an example, the controller circuitry 110 may physically rotate the first and second polarizers 128 and 132 to different axial orientations, or positions, independently using one or more motors 138 as indicated by arrows 140. In this example, the motor(s) 138 may be, for example, servo or step motors capable of incremental steps or movement such that the controller circuitry 110 may control the position of the motors(s) 138 via the I/O circuitry 112. The rotation of the motor(s) 138 may affect the relative orientation of the first polarizer 128, the second polarizer 132, and the crystal filter 130. The first and second polarizers 128 and 132 may physically rotate in a single direction or both directions with respect to the respective optical axis of the polarizer 128 and 132 to achieve a desired respective axial orientation with respect to a respective optical axis.

In addition, or alternatively, the first and second polarizers 128 and 132 may be electro-optically tunable polarizers. In this example, the controller circuitry 110 may use the I/O circuitry 112 to tune the first and second polarizers 128 and 132 using a variable output signal, such as an applied voltage to rotate the orientation of the polarizers 128 and 132 and/or the filter crystal 130. In some examples, the variable electric output signal output by the controller circuitry 110 may be electrical pulses to rotate the orientation of the second polarizer 132. For example, the first polarizer 128 and the second polarizer 132 may be electro-optical tunable polarizers in which the transmitted direction of linear polarization is tuned by an applied voltage. Thus, the polarization direction of the polarized light transmitted by the first and second polarizers 128 and 132 may be electrically controlled and/or physically controlled by the controller circuitry 110.

The controller circuitry 110 may control rotation of the first polarizer 128 to change the electromagnetic radiation wave of first polarization to another direction of polarization. In addition, the controller circuitry 110 may control rotation of the second polarizer to change the electromagnetic radiation wave of polarization transmitted by the second polarizer 132 to another direction of polarization to tune the electromagnetic radiation wave of second polarization. Thus, the controller circuitry may independently control rotation of the first polarizer 128 and the second polarizer 132. The first polarizer 128 may be rotated by the controller circuitry 110 to change the electromagnetic radiation wave of polarization output by the first polarizer 128 to another direction of polarization, and the second polarizer 132 may be rotated by the controller circuitry 110 to change the electromagnetic radiation wave of polarization output by the second polarizer 132 to another direction of polarization to tune the electromagnetic radiation wave of first polarization and the electromagnetic radiation wave of second polarization.

Further, in some examples, the controller circuitry 110 may calibrate the polarizers 128 and 132 by initially rotating the first and second polarizers 128 and 132 to a predetermined same direction of polarization, such as zero degrees, to align the first and second polarizers 128 and 132. Calibration of the first and second polarizers 128 and 132 may occur before the first polarizer 128 and the second polarizer 132 are rotatably and independently controlled by the controller circuitry 110 to tune the electromagnetic radiation wave of polarization transmitted by the first polarizer 128 and the electromagnetic radiation wave of polarization transmitted by the second polarizer 132. In some examples, the mechanical rotation of a polarizer may be a course control to obtain a desired direction of polarization and electrical rotation may be used as a fine control to obtain a desired direction of polarization. The terms “rotation,” “rotational,” “rotate,” or “rotated” as used herein to describe orientation of a polarizer 128 or 132 to achieve transmission of a direction of polarization of polarized light may refer to electrical rotation or mechanical rotation, or a combination thereof.

The crystal filter 130 may be positioned to receive polarized light transmitted in a polarization direction from the first polarizer 128 and transmit different wavelengths or frequencies of the polarized light received from the first polarizer 128 to the second polarizer 132. The different wavelengths may be separate and distinct polarized light frequencies that are polarized at different directions. Separation of the different frequency wavelengths of the polarized light transmitted in a polarization direction from the first polarizer 128 may be performed by the crystal filter 130 due to transmission at different rotation angles according to the different frequency wavelengths in the spectral range of the polarized light transmitted in a polarization direction from the first polarizer 128. Thus, the crystal filter 130 may be any crystal configurable to have dispersive optical qualities (DOA) such that wavelengths of received light are subject to different degrees of rotation according to the length of the propagated light.

In the tunable hyperspectral-polarimetric filter system 100, the crystal filter 130 may be substantially transparent and may have a dispersive optical-activity (DOA) at a spectral range of interest for spectral analysis. Examples of the crystal filter 130 include enantiomorphous crystals having a chiral structure and non-enantiomorphous crystals as further discuss herein. In an example where the spectral range of interest is 400-750 nm, the crystal filter 130 may be a quartz single crystal cut along the (0001) surface with a thickness greater than 2 mm. For example, the crystal filter 130 may be a quartz filter formed with opposing planar surfaces, where the atoms in the crystal filter 130 may be arranged in a trigonal shape, and the thickness is the distance between the planar opposing surfaces. In other examples, the atoms may be arranged in other shapes. In another example, where the spectral range of interest is 3.8-6 μm, the crystal filter 130 may be made of a tellurium (Te) single crystal cut along the (0001) surface with a thickness greater than 2 mm. For example, the crystal filter 130 may be formed with opposing planar surfaces, where the atoms in the crystal filter 130 may be arranged in a trigonal shape, and the thickness is the distance between the planar opposing surfaces. In other examples, the atoms may be arranged in other shapes. In still other examples, the filter crystal may be Se, TeO2, AgGaS2, Benzil, LiIO3, HlO3, Bi12GeO20, HgS, Hg3Te2Cl2, GaSe, (GaₓIn₁₋ₓ)₂Se₃, NaClO3, and NaBrO3 and other materials as described herein.

Different frequency wavelengths polarized at different directions may be transmitted as transmission spectra at each of a plurality of different polarization directions for receipt by the second polarization filter 132. The second polarization filter 132 may be a tunable spectral that generates a transmission spectra at each of a number of different polarization directions according to the rotational position of the second polarization filter 132. The first polarizer 128, the second polarizer 132, and the crystal filter 132 may include an anti-reflection coating on a surface at a spectral range of interest for increasing the intensity of transmitted light.

The controller circuitry 110 may include one or more processors and memories 118. The memory 118 may store, for example, control instructions that the processor executes to carry out desired functionality for the and/or the hyperspectral-polarimetric imaging filter 106. The memory 118 may also include control parameters to provide and specify configuration and operating options for the control instructions. The memory 118 may also store any generated data and/or data received via the I/O circuitry 112 and/or the user interface 114.

The I/O circuitry 112 may include capability to receive and transmit analog and/or digital signals. In addition, the i/O circuitry may include filtering capability, signal conversion capability, wireless and/or wireline communication capability and the like. The user interface 118 may include a graphical user interface, touch sensitive display, buttons, switches, speakers and other user interface elements. Additional examples of the I/O circuitry 112 and user interface 114 include microphones, video and still image cameras, temperature sensors, vibration sensors, rotation and orientation sensors, acceleration sensors, headset and microphone input/output jacks, universal serial bus (USB), serial advanced technology attachment (SATA), and peripheral component interconnect express (PCIe) interfaces and connectors, memory card slots, radiation sensors (e.g., infrared (IR) or radio frequency (RF) sensors), and other types of inputs. The I/O interfaces 120 may further include audio outputs, magnetic or optical media interfaces (e.g., a CDROM or DVD drive) or other types of serial, parallel, or network data interfaces.

The disclosed tunable hyperspectral-polarimetric imaging system 100 is a compact and inexpensive solution to hyperspectral-polarimetric imaging, where the intrinsic dispersion of optical activity in the filter crystal 130, such as chiral crystals including tellurium and quartz, may be used. The dispersive optical activity (DOA) based system provides superior spectral analysis while also enabling high-speed imaging and chip-level integration for use in the next-generation hyperspectral-polarimetric imaging provided by the system 100.

In the example illustrated in FIG. 1, the first polarizer 128 may receive the un-polarized light 124 from the lens 104, and transmit an electromagnetic radiation wave of first polarization 150 in a first direction of polarization, which is illustrated in FIG. 1 as the vertical direction by arrow 150. The electromagnetic radiation wave of first polarization 150 may include all wavelengths in a spectral range passed by the first polarizer 128. The crystal filter 130 may be in communication with the first polarizer 128 to receive the electromagnetic radiation wave of first polarization 150. The crystal filter 130 may, by optical dispersion, rotate the first direction of polarization for the electromagnetic radiation wave of first polarization 150 to generate a plurality of different frequency wavelengths 152 of the electromagnetic radiation wave of first polarization 250 at different rotation angles for each of the different frequency wavelengths in the spectral range. The second polarizer 132 may be in communication with the crystal filter 130 to receive the plurality of different frequency wavelengths and transmit an electromagnetic radiation wave of second polarization 154 in a second direction of linear polarization. In the example of FIG. 1, the second direction of linear polarization is illustrated by arrow 154 at about thirty degrees. The sensor 108 may sense and output a signal 156 indicative of a spectral image at a predetermined wavelength corresponding to the electromagnetic radiation wave of second polarization.

In an example of the hyperspectral-polarimetric imaging filter 106 where there is a first polarizer 128 followed sequentially be two or more optical groups 136, the electromagnetic radiation wave of second polarization 154 transmitted by the second polarizer 132 included in a first optical group 136 may be the electromagnetic radiation wave of first polarization 150 received by the crystal filter 130 included in a second optical group 136. Such a sequence of optical groups 136 may be of any number optical groups of two or more, and may sequentially adjust the second direction of linear polarization 154 transmitted by the second polarizers in a respective optical group 136 in degree steps according to the crystal orientation of each crystal filter 130 in the respective optical groups 136 through which the electromagnetic wave is transmitted.

The sensor 108 may sense the spectrum of whatever applicable electromagnetic radiation wave is being transmitted by the second polarizer 132. For example, the sensor 108 may be a CMOS camera, an infrared (IR) camera, or any other form of detector capable of detecting some portion of the electromagnetic spectrum.

### I. Dispersive Optical Activity (DOA)

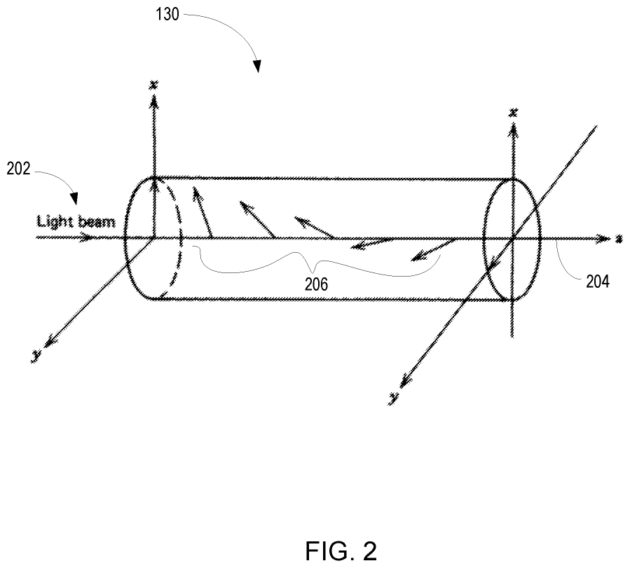

Dispersive Optical Activity (DOA) in the tunable hyperspectral-polarimetric imaging system 100 may be provided by the capability of the crystal filter 130 to rotate linear polarization direction as a light beam 202 travels along an optical axis 204 of the crystal filter 130. FIG. 2 is a schematic example of a crystal filter 130. As illustrated in FIG. 2, the crystal filter 130 transmits different frequency wavelengths 206 (illustrated by arrows in FIG. 2) at different angles of rotation, or rotation angles, based on optical activity arising from circular dichroism (or circular double refraction), in which the eigenmodes of wave propagations are right circularly polarized (RCP) waves and left circularly polarized (LCP) waves as solved from Maxwell's equations. The DOA effect of transmitting separate frequency wavelengths 206 at different angles of rotation may be exhibit in the system 100 in other crystals with chiral structures, such as silicon dioxide (SiO2), selenium (Se), tellurium (Te), and tellurium dioxide (TeO₂), Benzil, LiIO₃, HlO₃, Bi₁₂GeO₂₀, HgS, and Hg₃Te₂Cl₂, GaSe, (GaₓIn₁₋ₓ)₂Se₃. In addition, the DOA effect may be exhibited in the system 100 in non-enantiomorphous crystals, that is, crystals that do not have left and right-handed forms, such as silver gallium sulfide (AgGaS₂) and cadmium gallium sulfide (CdGa₂S₄). Also, based on symmetry of gyration tensor such dispersive optical activity may be provided by filter crystals from 15 classes among a total 32 crystal classes, in which eleven of the 15 crystal classes, namely classes 1, 2, 222, 4, 422, 3, 32, 6, 622, 432 and 23 are enantiomorphous and four of the crystal classes, namely classes m, mm2, ′4 and ′42 m, are non-enantiomorphous.

The amount of dispersion, or rotation, of each respective frequency wavelength 206 by the dispersive optical activity of the crystal filter 130 may have a rotation angle of polarization proportional to the light propagation length of the respective frequency wavelength 206, and may be quantitatively described by ‘rotatory power’ in a unit of degrees per millimeter. In addition, in the illustrated example, the diameter or thickness of the crystal filter 130 represents the length of the light path for each of the frequency wavelengths in the crystal filter 130. One interesting feature of the dispersal optical activity is that the rotatory power may have significant wavelength dependence. Accordingly, the dispersion may be quantitatively predicted by Eq. 1.

$$ρ = \frac{π}{λ} ( {n}_{l} - {n}_{r} ) \qquad ( 1 )$$

where ρ is the optical rotatory power, Δ is a frequency wavelength 206 of the propagating light beam wave 202 in vacuum, and nₗ and nᵣ are refractive index of a left-hand and a right-hand circularly polarized wave, respectively. With a fixed value of nₗ-nᵣ, the rotatory power may be inversely proportional to the frequency wavelength 206 because the different in fixed light path through the crystal filter 130 may lead to a different phase difference between LCP and RCP at different wavelengths. The dispersion by the crystal filter may be much faster than 1/Δ toward shorter wavelengths, which indicates nₗ and nᵣ also have significant wavelength-dependence. This ‘super-dispersion’ phenomenon may be theoretically described by axion electrodynamics and verified from first-principle calculations of the gyration tensor. The super-dispersion of optical activity by the crystal filter 130 in cooperative operation with the tunable first and/or second polarizers 128 and 132 may provide optimized spectral filtering and polarimetric imaging resolution by the tunable hyperspectral-polarimetric imaging system.

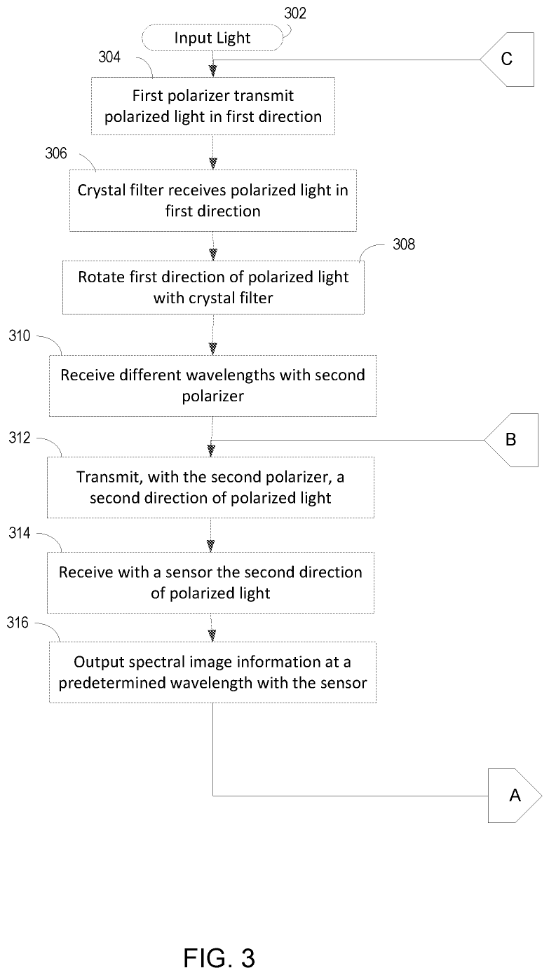

FIG. 3 is an operational flow diagram illustrating example operation of the tunable hyperspectral-polarimetric filter system 100. The operation may begin with receipt of input light by the first polarizer 128. (302) The input light may be electromagnetic radiation transmitted to the first polarizer 128. The first polarizer 128 may transmit polarized light in a spectral range of interest, where the transmitted light is substantially in a first direction of linear polarization. (304) The first polarizer 128 may generate an electromagnetic radiation wave of first polarization in a first direction of polarization, wherein the electromagnetic radiation wave of first polarization includes all wavelengths in a spectral range. The polarization selection may be substantially the same for all wavelengths at a spectral range of interest.

The crystal filter 13 may be in communication with the first polarizer 128, and may receive the polarized light transmitted from the first polarizer 128. (306) The crystal filter 130 may be, for example, parallelly and coaxially disposed after the first polarizer 128. The crystal filter 130 may rotate the first direction of polarization for light transmitted by the first polarizer 128. (308). The rotation angles differ for different wavelengths at the spectral range of interest. Accordingly, the crystal filter 130 may rotate the first direction of polarization for the electromagnetic radiation wave of first polarization to generate a plurality of different frequency wavelengths of the electromagnetic radiation wave of first polarization at the different rotation angles for each of the different frequency wavelengths in the spectral range.

The different wavelengths may be received by the second polarizer 132. (310) The second polarizer 132 may be in communication with the crystal filter 130 by, for example, being parallelly and coaxially disposed after the crystal filter 130. The second polarizer 128 may transmit a second direction of polarization of the light transmitted by the crystal filter 130. (312) The sensor 108 may sense, or receive, the second direction of polarization of the light. (314) The sensor 108 may output spectral information in a data signal to the controller circuitry 110. (316) The spectral information being at a predetermined wavelength corresponding to the polarization of light transmitted by the second polarizer 132 and being representative of a spectral image.

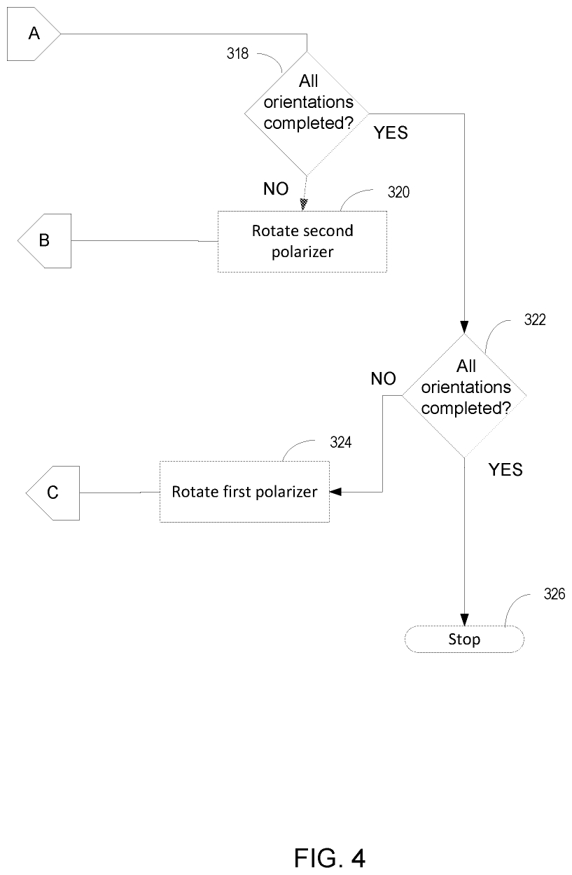

Referring now to FIG. 4, the controller circuitry 110 may confirm that all orientation (degrees of rotation) have been completed for the second polarizer 132. (318) If not, the controller circuitry 110 may rotate the second polarizer 132 to a new orientation (320) and return to transmitting, with the second polarizer a different second direction of polarized light according to the new rotational orientation of the second polarizer 132 at (312). If the second polarizer 128 has completed all rotational orientations (218), the controller circuitry 110 may determine if all rotational orientations are completed for the first polarizer 128. (322) If not, such as in the hyperspectral polarimetric imaging mode, the controller circuitry 110 may control rotation of the first polarizer 128 to a new rotational orientation, such as 0°, 45°, 90°, or −45° (324) and the operation may return to the first polarizer 128 transmitting polarized light in a different first direction. (304) If the first polarizer 128 has completed all the rotational orientations, or the first polarizer 128 remains stationary, such as in the hyperspectral imaging mode, the operation may stop.(326)

### II. Tunable Hyperspectral-Polarimetric Filter Example

The hyperspectral-polarimetric imaging filter 106 based on the aforementioned ‘super-dispersion’ of optical activity is shown in FIG. 1. The filter 106 includes the first and second linear polarizers (LP) 128 and 132 and the filter crystal 130 operable as a DOA crystal. The three components are coaxially placed in an order of first polarizer 128—crystal filter 130—second polarizer 132.

The first polarizer 128 substantially transmits one direction of linear polarization of incident light. Note that the polarization selection of the first polarizer 128 may transmit all wavelengths at the spectral range of interest. Thus, the first polarizer 128 may be a wire-grid polarizer in a range of wavelengths from ultraviolet (UV) to radiofrequency (RF). The first polarizer 128 may provide the polarization resolution of the filter 106, while the spectrum of the incident light transmitted through the first polarizer 128 is maintained.

Next, the incident light passes through the crystal filter 130, where the direction of linear polarization is rotated. The rotation angles differ for different wavelength frequencies. As a result, the transmitted light of the crystal filter 130 has different directions of linear polarization for different wavelength frequencies. Thus, the crystal filter 130 is a spectral dispersion element in the filter 106. However, unlike prisms in conventional spectrometers where different wavelengths are diffracted to different spatial positions, the polarization dispersion introduced by the filter crystal 130 makes it much easier for spectral filtering and provides for imaging spectroscopy.

Finally, the incident light passes through the second polarizer 132. The second polarizer 132 operates similar to a tunable spectral filter, where the transmission spectrum through the second polarizer 132 depends on the selected polarization direction. The transmission spectra output from the second polarizer 132 resemble the shape of a cosine function with shifted peak positions for different orientations of the second polarizer 132. For collecting polarimetric information of the incident light, the second polarizer 132 may rotate by itself or at the same time as the first polarizer, so that the transmission spectrum remains the same.

In an example, the controller circuitry 110 may operate the hyperspectral-polarimetric imaging filter 106 in a hyperspectral imaging mode or a hyperspectral polarimetric imaging mode. In the hyperspectral imaging mode, the transmitted polarization direction of the first polarizer 128 and the orientation of the crystal filter 130 may be fixed, and the transmitted linear polarization direction of the second polarizer 132 may be rotated, to tune the transmission spectrum of the system. In an example of this mode, the controller circuitry 110 may control rotation of the second polarizer 132 between zero and one-hundred and eighty degrees, while the first polarizer 128 remains stationary. This may be referred to as hyper spectral imaging since the resulting transmission of spectra by the second polarizer 132 results in different colors or wavelengths for each direction of polarization provided by the rotational position of the second polarizer 132.

In the hyperspectral polarimetric imaging mode, the transmitted linear polarization direction of the first polarizer 128, the orientation of the crystal filter 130, and the transmitted linear polarization direction of the second polarizer 132 may be rotated simultaneously, to tune the transmitted linear polarization direction of the system. In this mode, for example, the controller circuitry 110 may rotate the first polarizer to a polarizing direction, and then step the second polarizer 132 through a number of different rotational orientations (polarizing directions) before moving the first polarizer 128 to a different polarizing direction and then again stepping the second polarizer 132 through a number of different rotational orientations (polarizing directions). This process may be repeated as desired to obtain the desired spectral imaging.

In other example configurations, the first polarizer 128 and the second polarizer 132 may controlled by the controller circuitry 110 to rotate at two different rotational speeds and artificial intelligence (AI) may be used to pick out the spectra of the various polarization directions of the second polarizer 132 for each rotational position of the first polarizer 128. Training of the controller circuitry 110 to perform the AI may be based on introduction of electromagnetic radiation of known spectra output from first polarizer 128 and the second polarizer 132. In different examples, the crystal filter 130 may rotate synchronous with the first polarizer 128 or the second polarizer 132, or may independently rotate, or may be stationary during the hyperspectral imaging mode and/or the hyperspectral polarimetric imaging mode.

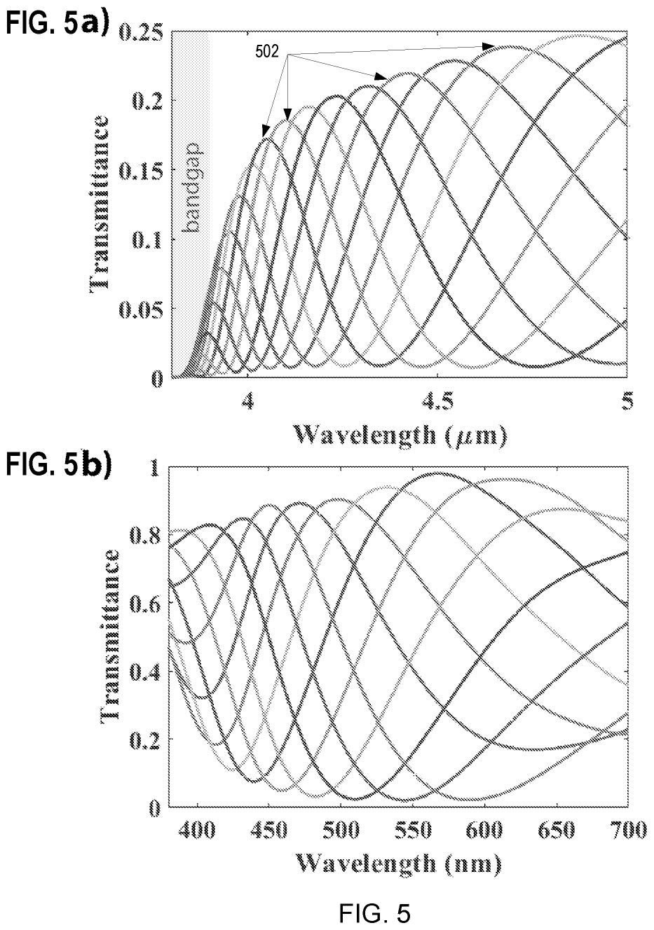

Based on the aforementioned design, a hyperspectral-polarimetric imaging filter 106 having an example electromagnetic radiation spectrum of mid-infrared (MWIR) may be implemented. In this example, the crystal filter 130 may be a single crystal tellurium (Te), which may have a large DOA below its bandgap (3.8 μm). In the example system, the first and second polarizers 128 and 132 may be wire-grid broadband infrared linear polarizers. In this example implementation, the crystal filter 130 may be a 10 mm-diameter and 2 mm-thick Te single crystal. In other examples, other polarizers (similar or different) may be used for the first and second polarizers 128 and 132, and the crystal filter 130 may be any other form of crystal capable of providing DOA characteristics. The transmission spectrum output from the second polarizer 132 of this example hyperspectral-polarimetric imaging filter 106 for each of a number of different rotational orientations, and therefore different polarizing directions, is shown in FIG. 5a. In the illustrated example, eight different spectra outputs 502 are illustrated for each of eight different degrees of rotation, or orientations of the second polarizer 132 between zero and one-hundred eighty degrees. By rotating the second linear polarizer 132, the transmission spectrum can be tuned in the entire MWIR region (3.8-6.5 mm).

Another example implementation of the hyperspectral-polarimetric imaging filter 106 may be implemented at the visible spectrum. The filter may include, for example, a 50 mm-diameter and 5 mm-thick quartz single crystal as the crystal filter 130 performing DOA. This example crystal filter 130 may include a relatively large DOA at the visible, and such quartz single crystals may also show high peak transmission even without anti-reflection coatings. In addition, quartz crystal is cost-effective due to it's currently wide used in various industries. The spectral filtering performance of this example hyperspectral-polarimetric imaging filter 106 is shown in FIG. 5b. In this example, the tuning range may cover the entire visible spectrum (380-700 nm) and the peak transmittance may be higher than 0.8 for at least some of the spectra outputs 502. Thus, this example implementation may provide an ideal platform for use in imaging applications.

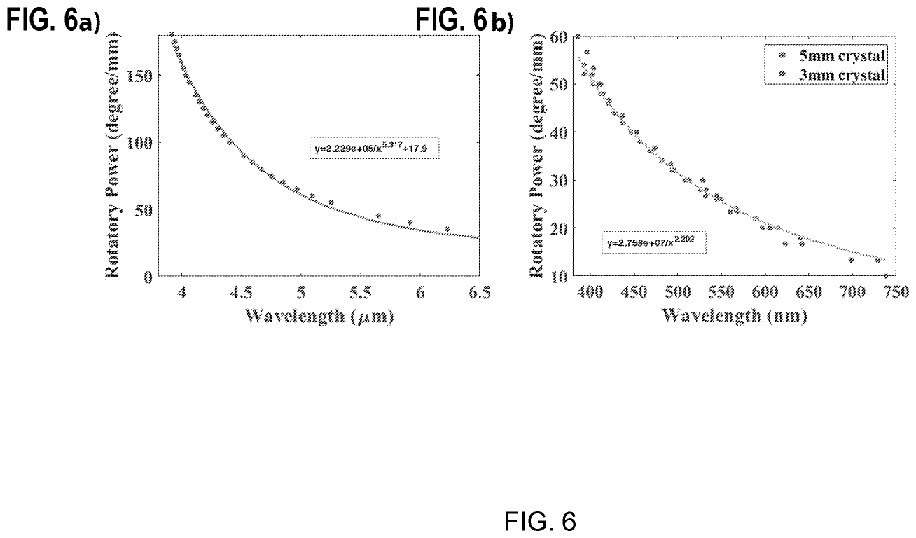

As further evidence of the superior performance of the hyperspectral-polarimetric imaging filter 106, in examples with the crystal filter 130 implemented as Te and Quartz, the optical rotatory power of Te and quartz were calculated through the measured transmission spectra provided in FIGS. 5a and 5b, and plotted in FIG. 6a and FIG. 6b, respectively. The data points were obtained by finding the local maximum/minimum in each of the spectra, which correspond to a polarization rotation angle of nΠ/2 (n=0,1,2,3 . . . ), respectively. In this example, the rotatory power was fitted through power functions. Both the DOAs of Te and quartz single crystals are faster than 1/Δ, which proves that ‘super-dispersion’ in the crystal filter 130 plays an important role in the performance of spectral filtering.

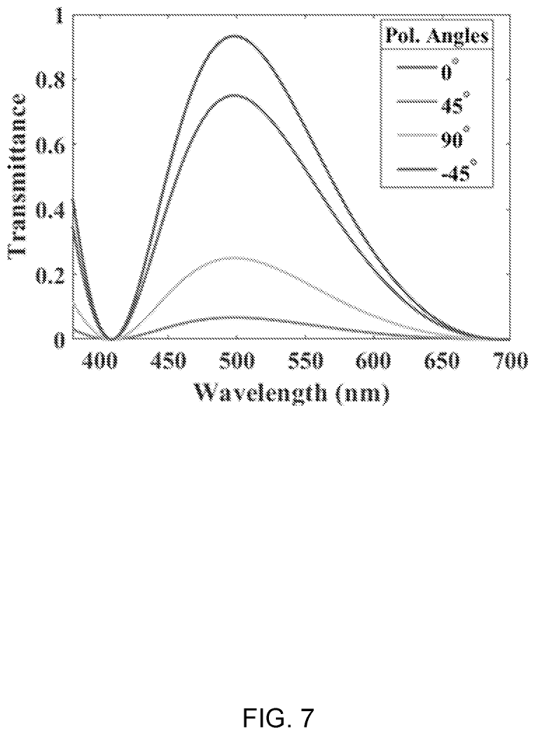

FIG. 7 is an example tunable transmission spectrum output by rotating both the first polarizer 128 and the second polarizer 132 to polarity angles of 0°, 45°, 90°, and −45°. In this example, the input light 122 is linearly polarized.

III. Hyperspectral-Polarimetric Imaging System example

The tunable hyperspectral-polarimetric filter 106 may be implemented within the hyperspectral-polarimetric imaging system 100.

In an example hyperspectral-polarimetric imaging system 100, the tunable hyperspectral-polarimetric filter 106 may include a quartz based crystal filter 130. In this example, the hyperspectral-polarimetric imaging system 100 may be implemented in a camera, such as a commercial CMOS camera by directly mounting the tunable hyperspectral-polarimetric filter 106 system in front of an imaging len(s) 104 of the camera. A CMOS image sensor included in the camera may receive light transmitted as transmission spectra from the second polarizer 132.

The hyperspectral-polarimetric imaging system 100 may receive light from a scene, where the hyperspectral-polarimetric imaging system 100 is adapted to generate a plurality of spectral frames and a plurality of linear polarization frames associated with the scene. Each of the plurality of spectral frames and the plurality of linear polarization frames having a plurality of pixels. For each pixel from the generated plurality of spectral frames, the system may extract spectral information associated with the scene, and for each pixel from the generated plurality of linear polarization frames, the system may generate Stokes parameters, angle of linear polarization, and degree of linear polarization associated with the scene.

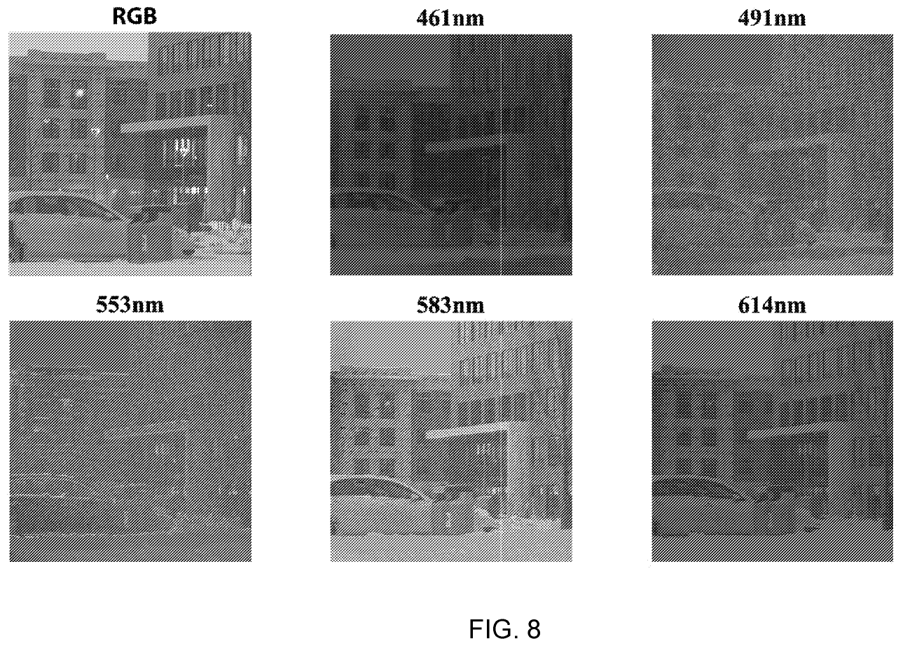

Spectral information associated with the scene may be extracted by the hyperspectral-polarimetric imaging system 100 for each pixel from the generated plurality of spectral frames (i). In an example, 100 spectral frames may be obtained while the second polarizer in the filter system rotates from 0 to 180°. The original spectrum associated with the scene at each pixel may be extracted from the i spectral frames based on Eq. 2.

$${S}_{v} = {\sum }_{i} {M}_{vi} {N}_{i} \qquad ( 2 )$$

where Nᵢ represents the output signal of a single-pixel in the i frame among the total 100 spectral frames. Mᵥᵢ is a pre-calibrated linear transformation matrix for the hyperspectral-polarimetric imaging system, which can be trained with many pure color/spectrum images with spectra measured by a spectrometer. Sᵥ represents the extracted spectral information. Examples of some reconstructed false-color spectral images, which may be generated in the user interface 114 by the hyperspectral-polarimetric imaging system 100 are shown in FIG. 8.

For each pixel from the generated plurality of linear polarization frames from the example hyperspectral-polarimetric imaging system 100, a predetermined number, such as four linear polarization frames may be obtained by rotation of the first polarizer 128. For example, linear polarization at 0°, 45°, 90°, and −45° may be obtained by rotational orientation control of the first polarizer 128 by the controller circuitry 110. Then, three linear Stokes parameters (S0, S0, S0) may be calculated by the hyperspectral-polarimetric imaging system 100 from the I₀, I₄₅, I₉₀, and I₄₅ frames based on Eq. 3.

$$\begin{matrix}{S}_{0} = {I}_{0} + {I}_{90} \\ {S}_{1} = {I}_{0} - {I}_{90} \\ {S}_{2} = {I}_{45} - {I}_{- 45}\end{matrix} \qquad ( 3 )$$

For each pixel from the plurality of linear polarization frames generated from the hyperspectral-polarimetric imaging system 100, the degree of linear polarization (DoLP) associated with the scene may be obtained by the hyperspectral-polarimetric imaging system 100 from Eq. 4.

$$D o L P = \sqrt{{S}_{1}^{2} + {S}_{2}^{2}} / {S}_{0} \qquad ( 4 )$$

For each pixel from the generated plurality of linear polarization frames from the hyperspectral-polarimetric imaging system 100, the generated angle of linear polarization (AoLP) associated with the scene may be obtained by the hyperspectral-polarimetric imaging system 100 from Eq. 5.

$$AoLP = arctan ( {S}_{2} / {S}_{1} ) \qquad ( 5 )$$

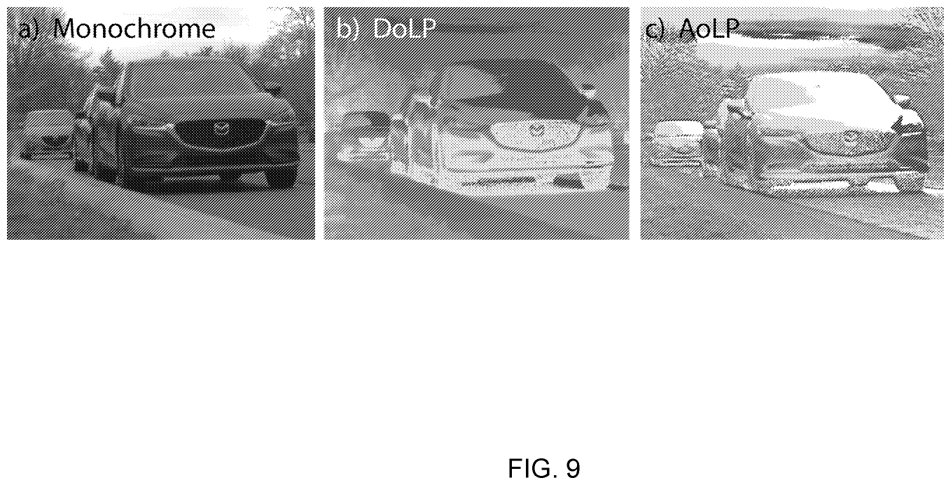

An example DoLP image and an AoLP image, which may be generated in the user interface 114 of the hyperspectral-polarimetric imaging system 100 are shown in FIG. 9b and FIG. 9c, respectively, and compared with the original monochromatic image FIG. 9a received as input light 122. Since Stokes parameters are a complete description of the polarization of light, the generated DoLP and AoLP images contain substantially all the information about linear polarization associated with a scene, which can be analyzed for the use of a variety of applications.

The methods, devices, processing, circuitry, and logic described above may be implemented in many different ways and in many different combinations of hardware and software. For example, all or parts of the controller circuitry 110 and the I/O circuitry 112 may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in the memory 118 which is a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the controller circuitry 110.

In some examples, each unit, subunit, and/or module of the system 100 may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that comprises instructions executable with the processor or other processors to implement one or more of the features of the logical components. When any one of the logical components includes the portion of the memory that comprises instructions executable with the processor, the logical component may or may not include the processor. In some examples, each logical components may just be the portion of the memory or other physical memory that comprises instructions executable with the processor or other processor to implement the features of the corresponding logical component without the logical component including any other hardware. Because each logical component includes at least some hardware even when the included hardware comprises software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

We claim:

1. A tunable hyperspectral-polarimetric imaging system, comprising:
a first polarizer configured to transmit an electromagnetic radiation wave of first polarization in a first direction of polarization, wherein the electromagnetic radiation wave of first polarization includes all wavelengths in a spectral range;
a crystal filter in communication with the first polarizer to receive the electromagnetic radiation wave of first polarization, wherein the crystal filter is configured to rotate the first direction of polarization for the electromagnetic radiation wave of first polarization to generate a plurality of different frequency wavelengths of the electromagnetic radiation wave of first polarization at different rotation angles for each of the different frequency wavelengths in the spectral range;
a second polarizer in communication with the crystal filter to receive the plurality of different frequency wavelengths and transmit an electromagnetic radiation wave of second polarization in a second direction of polarization; and
a sensor configured to sense and output a signal indicative of a spectral image at a predetermined wavelength corresponding to the electromagnetic radiation wave of second polarization.

2. The tunable hyperspectral-polarimetric imaging system of claim 1, further comprising controller circuitry configured to rotate the second polarizer to change the electromagnetic radiation wave of second polarization to another second direction of polarization to tune the electromagnetic radiation wave of second polarization.

3. The tunable hyperspectral-polarimetric imaging system of claim 1, wherein the crystal filter comprises at least one of quartz, Te, Se, TeO₂, AgGaS₂, Benzil, LiIO₃, HlO₃, Bi₁₂GeO₂₀, HgS, Hg₃Te₂Cl₂, GaSe or (GaₓIn₁₋ₓ)₂Se₃.

4. The tunable hyperspectral-polarimetric imaging system of claim 1, wherein the crystal filter is a crystal in a crystal class, the crystal class comprising class 1, class 2, class 222, class 4, class 422, class 3, class 32, class 6, class 622, class 432, class 23, class m, class mm2, class 4 or class 42 m.

5. The tunable hyperspectral-polarimetric imaging system of claim 1, wherein the crystal filter is substantially transparent and has dispersive optical-activity (DOA) at the spectral range.

6. The tunable hyperspectral-polarimetric imaging system of claim 1, further comprising controller circuitry configured to independently rotate the first polarizer and the second polarizer, the first polarizer rotated by the controller circuitry to change the electromagnetic radiation wave of first polarization to another first direction of polarization, and the second polarizer rotated by the controller circuitry to change the electromagnetic radiation wave of second polarization to another second direction of polarization to tune the electromagnetic radiation wave of first polarization and the electromagnetic radiation wave of second polarization.

7. The tunable hyperspectral-polarimetric imaging system of claim 6, wherein the controller circuitry is configured to initially rotate the first polarizer and the second polarizer to a predetermined same direction of polarization to align the first polarizer and the second polarizer, before independent rotation of the first polarizer and the second polarizer to tune the electromagnetic radiation wave of first polarization and the electromagnetic radiation wave of second polarization.

8. The tunable hyperspectral-polarimetric imaging system of claim 1, further comprising a motor configured to physically rotate at least one of the first polarizer, the second polarizer, or the crystal filter.

9. The tunable hyperspectral-polarimetric imaging system of claim 1, further comprising a controller circuitry configured to rotate the first polarizer, the second polarizer, or both, wherein the first polarizer, or the second polarizer, or both comprise an electro-optically tunable polarizer tunably controlled by control signals from the controller circuitry.

10. The tunable hyperspectral-polarimetric imaging system of claim 1, wherein the spectral range of the electromagnetic radiation wave is in a range of frequencies from 400 nm to 750 nm, wherein the crystal filter comprises a quartz single crystal cut along a (0001) surface.

11. The tunable hyperspectral-polarimetric imaging system of claim 1, wherein the spectral range of the electromagnetic radiation wave is in a range of frequencies from 3.8 μm to 6 μm, wherein the crystal filter comprises a tellurium (Te) single crystal cut along a (0001) surface.

12. The tunable hyperspectral-polarimetric imaging system of claim 1, wherein the first polarizer and the second polarizer are linear polarizers, and the electromagnetic radiation wave of first polarization is a linear electromagnetic radiation wave of first polarization, and the electromagnetic radiation wave of second polarization is a linear electromagnetic radiation wave of second polarization.

13. The tunable hyperspectral-polarimetric imaging system of claim 1, wherein the crystal filter comprises a plurality of crystal filters and the second polarizer comprises a plurality of second polarizers, and wherein a first one of the crystal filters and a first one of the second polarizers are optically aligned to form a first group, and a second one of the crystal filters and a second one of the second polarizers are optically aligned to form a second group, the first group optically and sequentially aligned with the first polarizer, such that the first one of the crystal filters is in optical communication with the first polarizer, and the first one of the second polarizers is optically aligned to optically communicate with the second one of the crystal filters.

14. The tunable hyperspectral-polarimetric imaging system of claim 13, wherein the crystal filters comprise right-handed crystals having a clockwise rotational direction of polarization for the electromagnetic radiation wave and left-handed crystals having a counter-clockwise rotational direction of polarization for the electromagnetic radiation wave.

15. A method of image analysis comprising:
transmitting electromagnetic radiation through a first polarizer;
generating, with the first polarizer, an electromagnetic radiation wave of first polarization in a first direction of polarization, wherein the electromagnetic radiation wave of first polarization includes all wavelengths in a spectral range;
receiving, with a crystal filter in communication with the first polarizer, the electromagnetic radiation wave of first polarization;
rotating, with the crystal filter the first direction of polarization for the electromagnetic radiation wave of first polarization to generate a plurality of different frequency wavelengths of the electromagnetic radiation wave of first polarization at different rotation angles for each of the different frequency wavelengths in the spectral range;
receiving, with a second polarizer in communication with the crystal filter the plurality of different frequency wavelengths;
transmitting, with the second polarizer, an electromagnetic radiation wave of second polarization in a second direction of polarization;
sensing, with a sensor, the electromagnetic radiation wave of second polarization; and
outputting, with the sensor, a signal representative of a spectral image at a predetermined wavelength corresponding to the electromagnetic radiation wave of second polarization.

16. The method of claim 15, further comprising controlling, with a controller circuitry, rotation of the first polarizer to change the electromagnetic radiation wave of first polarization to another first direction of polarization, and controlling, with the controller circuitry, rotation of the second polarizer to change the electromagnetic radiation wave of second polarization to another second direction of polarization to tune the electromagnetic radiation wave of first polarization and the electromagnetic radiation wave of second polarization.

17. The method of claim 15, further comprising controlling, with a controller circuitry, rotation of the second polarizer to change the electromagnetic radiation wave of second polarization to another second direction of polarization to tune the electromagnetic radiation wave of second polarization.

18. The method of claim 15, further comprising sequentially rotating the second polarizer to a plurality of different rotatable orientations to change the electromagnetic radiation wave of second polarization to multiple different corresponding second directions of polarization to tune the electromagnetic radiation wave of second polarization.

19. A tunable hyperspectral-polarimetric imaging system, comprising:
a first polarizer configured to generate from electromagnetic radiation a polarized electromagnetic radiation of one direction comprising a plurality of wavelengths;
a crystal filter in optical axial alignment with the first polarizer, the crystal filter configured to receive and dispersively rotate the polarized electromagnetic radiation of one direction with a different rotation angle for each of the wavelengths to generate a different direction of polarization for each respective wavelength;
a second polarizer in optical axial alignment with the crystal filter, the second polarizer configured as a tunable spectral filter to generate a transmission spectra at each of a plurality of different polarization directions according to an axial orientation of the second polarizer with respect to an optical axis of the second polarizer; and
a sensor configured to generate a spectral frame for the transmission spectra at each of the plurality of different polarization directions, the spectral frame representative of a spectral image at a respective polarization direction.

20. The tunable hyperspectral-polarimetiric imaging system of claim 19, further comprising a controller circuitry configured to axially rotate the second polarizer to each of the different polarization directions.
